(19) United States
(12) Patent Application Publication
(10) Pub. No.: US 2010/0120412 A1
(43) Pub. Date: May 13, 2010

(54) METHOD, SYSTEM AND RNC FOR IMPLEMENTING SERVICE FUNCTIONS IN SHARED RADIO ACCESS NETWORK

(75) Inventors: Zongquan TANG, Shenzhen (CN); Yong LIU, Shenzhen (CN); Junhai MIAO, Shenzhen (CN); Wangzhi YE, Shenzhen (CN); Wansheng YE, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/689,530

(22) Filed: Jan. 19, 2010

Related U.S. Application Data
(63) Continuation of application No. PCT/CN2008/072423, filed on Sep. 19, 2008.

(30) Foreign Application Priority Data
Sep. 19, 2007 (CN) 200710154178.1

(51) Int. Cl. H04W 40/00

(52) U.S. Cl. 455/422.1

(57) ABSTRACT

The present invention provides a method, system, and RNC for implementing service functions in a shared radio access network (RAN). The method includes: dividing different subsystems of a physical radio network controller (RNC) into different logical RNCs and coupling each logical RNC to at least one service function entity, where the service function entity belongs to at least one operator and service function entities of different operators implement independent service functions through coupled logical RNCs. The present invention also provides a system and RNC for implementing service functions in a shared RAN. With the present invention, different operators in a shared RAN may use different service function entities to meet their own service function requirements.

### CROSS-REFERENCE TO RELATED APPLICATIONS

This application is a continuation of International Patent Application No. PCT/CN2008/072423, filed Sep. 19, 2008, which claims priority to Chinese Patent Application No. 200710154178.1, filed Sep. 19, 2007, both of which are hereby incorporated by reference in their entireties.

### FIELD OF THE INVENTION

The present invention relates to radio network technologies, and in particular, to a method, system, and Radio Network Controller (RNC) for implementing service functions in a shared Radio Access Network (RAN).

### BACKGROUND OF THE INVENTION

In a third generation (3G) mobile communication system, an RAN provides various service functions for accessed terminals in radio modes. Various service function entities on the network are coupled to the RAN to implement different service functions.

RANs may be classified into non-shared RANs and shared RANs according to the number of service function entities that may be coupled to an RAN and the number of operators whom the RAN belongs.

FIG. 1 shows a network structure for providing a Cell Broadcast Service (CBS) in a non-shared RAN in the conventional art. In this network structure, one RNC is coupled to only one Cell Broadcast Centre (CBC). The broadcast messages from the CBC are sent on the NodeB coupled to the RNC. The RNC and the CBC belong to the same operator; that is, they are privately used only by one operator.

FIG. 2 shows a network structure for providing a CBS in a shared RAN in the conventional art. In this network structure, one RNC is coupled to one CBC. The RNC and the CBC may belong to multiple operators; that is, they are shared by multiple operators.

Similarly, FIG. 3 shows a network structure for providing a location service (LCS) in a shared RAN in the conventional art. In this network structure, one RNC is coupled to one Stand Alone Serving Mobile Location Centre (SAS). The RNC and the SAS may belong to multiple operators; that is, they are shared by multiple operators.

During the research on and practice of the conventional art, however, it is found that different operators in a shared RAN have different service function requirements. Thus, the conventional art fails to meet service function requirements of different operators.

### SUMMARY

Embodiments of present invention provide a method, system and RNC for implementing service functions in a shared RAN to meet service function requirements of different operators.

An embodiment of the present invention provides a method for implementing service functions in a shared RAN includes: dividing subsystems of a physical RNC into at least two logical RNCs and coupling the at least two logical RNCs to at least two service function entities, where any one of the service function entities implements independent service functions through the corresponding logical RNC.

Another embodiment of the present invention provides a system for implementing service functions in a shared RAN includes at least two logical RNCs divided according to subsystems of a physical RNC and at least two service function entities coupled to the at least two logical RNCs. Each of the service function entities belongs to at least one operator, and is configured to implement independent service functions through the corresponding logical RNC coupled to the service function entity.

Another embodiment of the present invention provides an RNC for implementing service functions in a shared RAN includes at least two logical RNCs divided according to subsystems of a physical RNC, where the at least two logical RNCs are coupled to at least two service function entities, and where any one of the service function entities implements independent service functions through the corresponding logical RNC.

Another embodiment of the present invention provides a method for implementing service functions in a shared RAN includes: (1) coupling corresponding service function entities of different operators to different logical RNCs in the same physical RNC, where the logical RNCs are configured by dividing different subsystems of the physical RNC and each logical RNC is coupled to at least one service function entity; and (2) coupling each service function entity to a logical RNC to implement an independent service function; and multiple service function entities implement different service functions if the multiple service function entities couples to a same logical RNC.

As shown in the technical solution in embodiments of the present invention, different subsystems of a physical RNC are divided into different logical RNCs; each logical RNC is coupled to at least one service function entity; and service function entities of different operators implement independent service functions through the coupled logical RNCs. In this way, different operators in a shared RAN may use different service function entities to meet their own service function requirements.

### BRIEF DESCRIPTION OF THE DRAWINGS

FIG. 1 shows a network structure for providing a CBS in a non-shared RAN in the conventional art;

FIG. 2 shows a network structure for providing a CBS in a shared RAN in the conventional art;

FIG. 3 shows a network structure for providing an LCS in a shared RAN in the conventional art;

FIG. 4 shows a flowchart of a method for implementing service functions in a shared RAN in an embodiment of the present invention;

FIG. 5 shows coupling relationship between logical RNCs and service function entities in dedicated mode in an embodiment of the present invention;

FIG. 6 shows coupling relationship between logical RNCs and service function entities in partially shared mode in an embodiment of the present invention;

FIG. 7 shows coupling relationship between logical RNCs and service function entities in completely shared mode in an embodiment of the present invention;

FIG. 8 shows coupling relationship between an RNC and multiple service function entities in an embodiment of the present invention;

FIG. 9 shows a network structure for implementing an independent CBS for three operators in an embodiment of the present invention; and

FIG. 10 shows a network structure for implementing an independent LCS for two operators in an embodiment of the present invention.

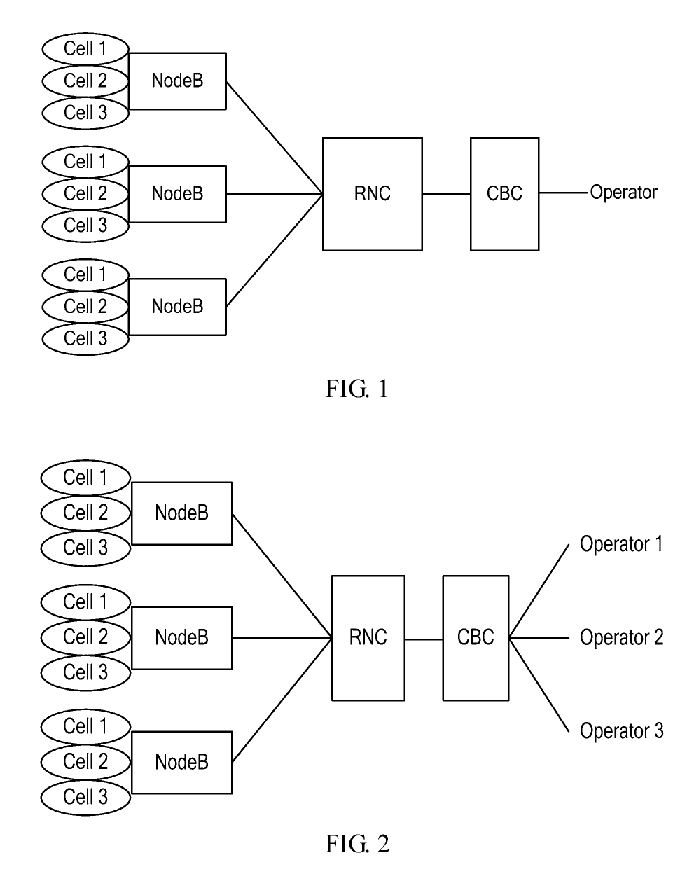

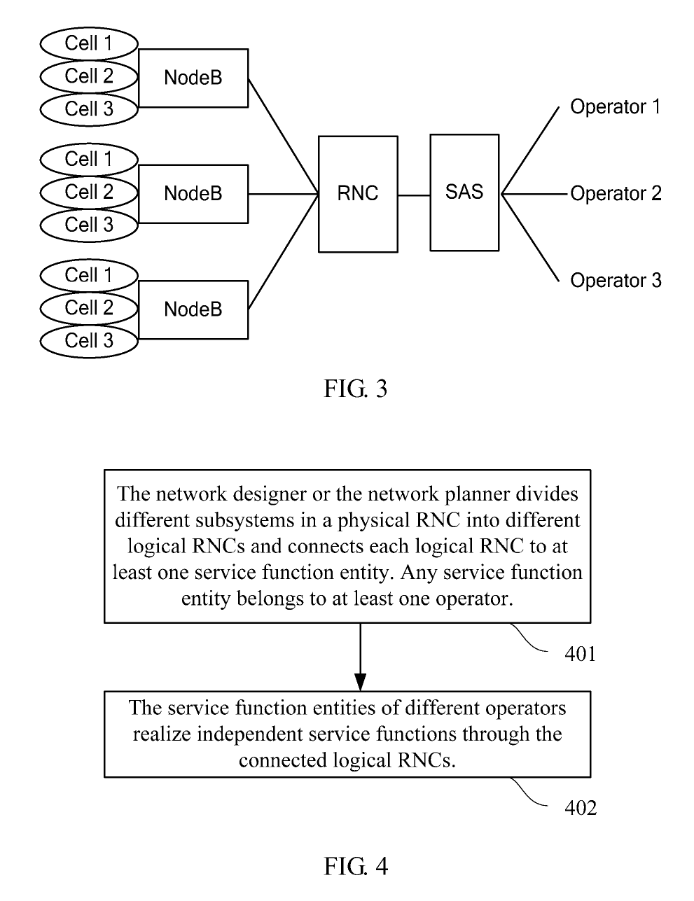

### DETAILED DESCRIPTION OF THE EMBODIMENTS

Embodiments of the present invention provide a method, system, and RNC for implementing service functions in a shared RAN.

By analysis, the inventor finds that different operators in a shared RAN have different service function requirements in the conventional art. Thus, the same service function entity in a shared RAN fails to meet service function requirements of different operators. For example, different operators in a shared RAN have different requirements for the CBS, including the contents, performance, and privacy. Thus, it is unreasonable to force all the operators in the shared RAN to use the same CBC. In another example, different operators in a shared RAN have different requirements for an LCS, including the location traffic, location precision, location method, and location information format. Thus, it is unreasonable to force all the operators in the shared RAN to use the same SAS.

To help those skilled in the art better understand the technical solution, the following further describes the present invention in detail with reference to accompanying drawings and embodiments.

FIG. 4 shows a flowchart of a method in an embodiment of the present invention. The method may be implemented by a network designer or by a network planner. Specific implementation steps are as follows:

Step 401: Divides different subsystems of a physical RNC into different logical RNCs and couples each logical RNC to at least one service function entity. Any service function entity belongs to at least one operator.

One physical RNC includes multiple subsystems. A subsystem may include one Central Processing Unit (CPU). One physical RNC may use multiple subsystems of it to complete the functions of an RNC. Specifically, each subsystem may complete a part of the tasks of an RNC. The sum of the tasks completed by various subsystems is the total of tasks completed by the RNC.

Thus, one physical RNC may be divided into different logical RNCs according to its subsystems. In other words, one subsystem in a physical RNC may serve as a logical RNC. In this way, a physical RNC may include multiple logical RNCs. Each logical RNC has the capability of completing the tasks of an RNC independently from the view of functions. Thus, one logical RNC may be coupled to one service function entity. That is, one physical RNC may be coupled to multiple service function entities through multiple logical RNCs in the physical RNC.

For example, suppose that a shared RAN includes three operators. The RNCs and service function entities may be coupled in three modes:

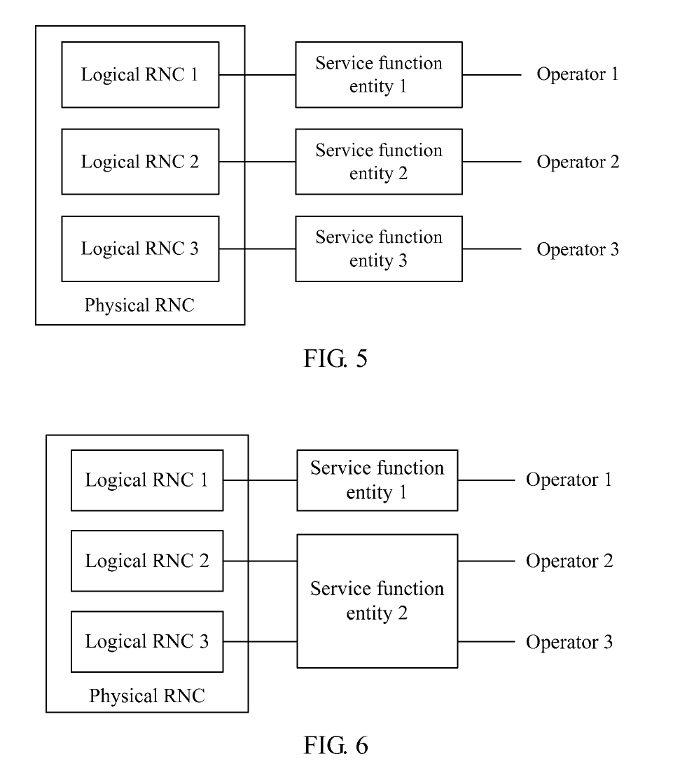

1. Dedicated mode: As shown in FIG. 5, the three subsystems of the physical RNC are divided into three logical RNCs. Each logical RNC is independently coupled to one service function entity and each service function entity belongs to one operator. In general, in this mode, each logical RNC is independently coupled to one service function entity.

2. Partially shared mode: As shown in FIG. 6, the three subsystems of the physical RNC are divided into three logical RNCs. Logical RNC 1 is coupled to service function entity 1 that belongs to operator 1. Logical RNC 2 and logical RNC 3 are both coupled to service function entity 2 that belongs to operators 2 and 3. In general, in this mode, at least one logical RNC is independently coupled to one service function entity and at least two logical RNCs are coupled to the same service function entity.

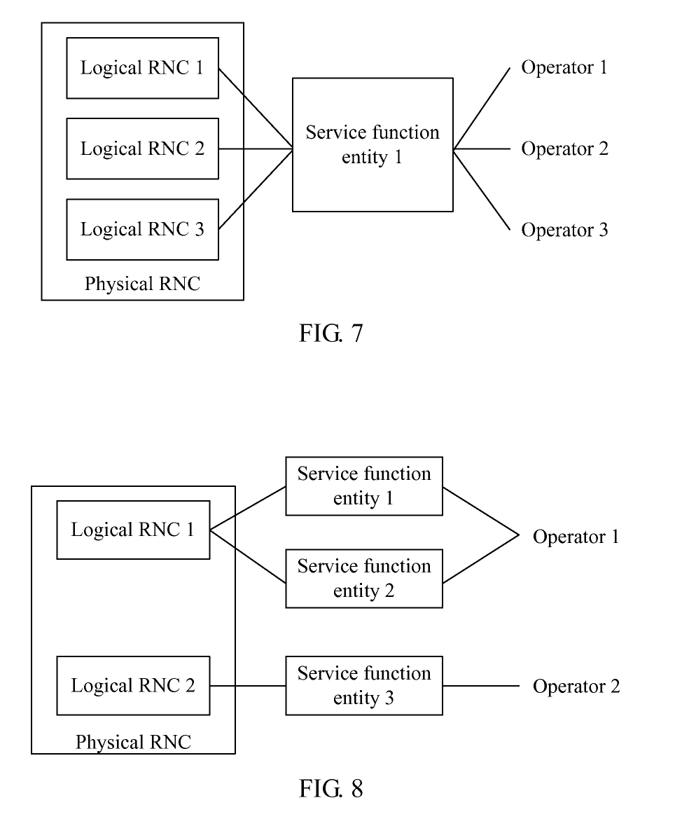

3. Completely shared mode: As shown in FIG. 7, the three subsystems of the physical RNC are divided into three logical RNCs. The three logical RNCs are all coupled to service function entity 1 that belongs to operators 1, 2, and 3. In general, in this mode, all the logical RNCs are coupled to the same service function entity.

It should be noted that one logical RNC needs to be coupled to at least one cell. Similar to the physical RNCs in the conventional art, logical RNCs may control corresponding cells to implement radio functions. Each operator may have different cells. Thus, the corresponding logical RNC of an operator may be coupled to one or more cells. In this case, the frequency range of each operator is usually different. In addition, the user equipment (UE) of the Third Generation Partnership Project (3GPP) R99, 3GPP R4, and 3GPP R5 may support this function. Thus, there is no protocol compatibility problem.

Multiple service function entities may be coupled to the same logical RNC to implement different service functions. As shown in FIG. 8, logical RNC 1 is coupled to service function entities 1 and 2. The two service function entities are used to implement different service functions. For example, service function entity 1 serves as a CBC and service function entity 2 serves as an SAS. Service function entities 1 and 2 coupled to logical RNC 1 may belong to the same operator.

Step 402: The service function entities of different operators implement independent service functions through the coupled logical RNCs.

The service function entity may be a CBC. In this case, the CBCs of different operators implement independent CBSs through the coupled logical RNCs. As specified by the Service Area Broadcast Protocol (SABP) related to the interface between the RNC and the CBC in 3GPP standards, one RNC may be coupled to only one CBC. In the embodiment where one physical RNC can be coupled to multiple CBCs, the RNC can still normally support the broadcast function in the service area because the logical RNCs still comply with the SABP protocol of the interface.

The service function entity may be an SAS. In this case, the SASs of different operators implement independent LCSs through the coupled logical RNCs. As specified by the Position Calculation Application Part (PCAP) protocol related to the interface between the RNC and the SAS in 3GPP standards, one RNC may be coupled to only one SAS. In the embodiment where one physical RNC may be coupled to multiple SASs, the RNC can still normally support the location function because the logical RNCs still comply with the PCAP protocol of the interface.

The service function entity may be an entity that implements other service functions.

The following describes how to implement the CBS and LCS.

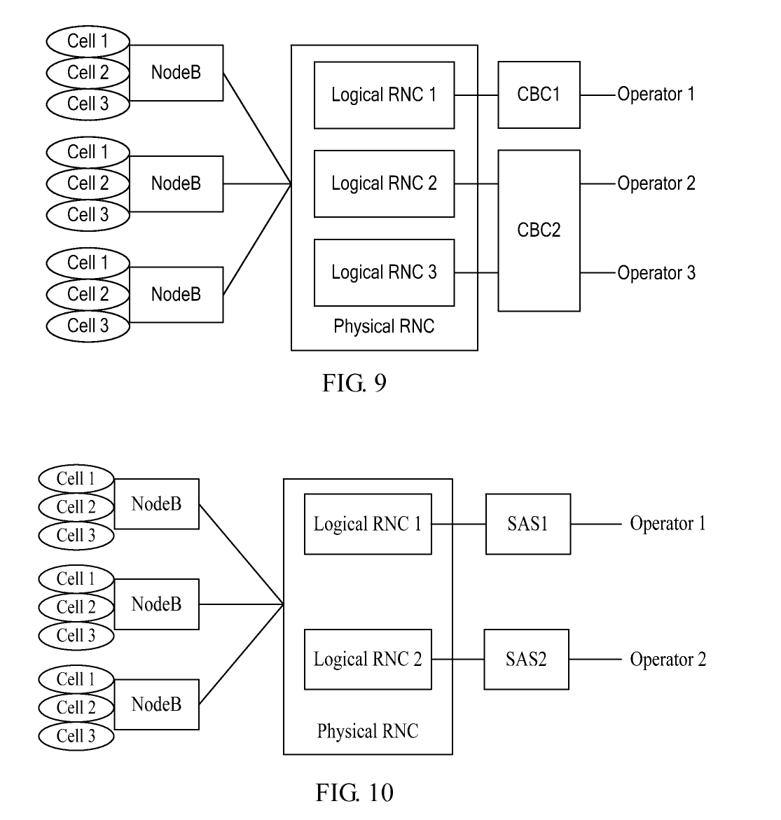

FIG. 9 shows a network structure for providing an independent CBS for three operators in a shared RAN.

In this network structure, three operators share a physical RNC. CBC 1 is used only by operator 1 and is coupled to logical RNC 1. CBC 2 is shared by operators 2 and 3 and is coupled to logical RNC 2 and logical RNC 3 respectively. This mode is known as the above-mentioned partially shared mode. In addition, the contents, performance, and privacy of the CBS implemented by CBC 1 and CBC 2 are different. Thus, operator 1 may use CBC 1 to implement cell broadcast according to requirements of operator 1. Operators 2 and 3 may use CBC 2 to implement cell broadcast according to their own requirements. For example, the CBS information of operator 1 is sent to logical RNC 1 in a shared RNC through CBC 1 of operator 1, and the CBS information is broadcast in the cell that is coupled to logical RNC 1 and belongs to operator 1. The CBS information of operators 2 and 3 is sent to logical RNC 2 and logical RNC 3 in the shared RNC respectively through CBC 2 shared by operators 2 and 3, and the CBS information of operators 2 is broadcast in the cell that is coupled to logical RNC 2 and belongs to operator 2 and the CBS information of operators 3 is broadcast in the cell that is coupled to logical RNC 3 and belongs to operator 3 respectively.

Thus, different operators may use different CBCs to implement the CBS according to their requirements for the contents, performance, and privacy.

FIG. 10 shows a network structure for providing an independent LCS for two operators in a shared RAN.

In this network structure, two operators share a physical RNC. SAS 1 is used only by operator 1 and is coupled to logical RNC 1. SAS 2 is used only by operator 2 and is coupled to logical RNC 2. This mode is known as the above-mentioned dedicated mode. In the LCSs implemented by SAS 1 and SAS 2, the location traffic, location precision, location method, and location information format are different. For example, a location request of operator 1 is sent to logical RNC 1 in the shared RNC. After the cells that are coupled to logical RNC 1 and belong to operator 1 or the UEs covered by these cells complete location measurement, the measurement results are returned to SAS 1 through logical RNC 1. Then SAS 1 calculates the measurement results and may further perform subsequent operations. Similarly, a location request of operator 2 is sent to logical RNC 2 in the shared RNC. After the cells that are coupled to logical RNC 2 and belong to operator 2 or the UEs covered by these cells complete location measurement, the measurement results are returned to SAS 2 through logical RNC 2. Then SAS 2 calculates the measurement results and may further perform subsequent operations.

When the shared RNC is coupled to multiple SASs, the global positioning system (GPS) data required in the assisted GPS (A-GPS) location method is usually provided by the SASs. That is, the shared RNC obtains GPS data by exchanging information with the dedicated SASs of various operators. This can be completed by the A-GPS technology. The A-GPS technology is used to provide auxiliary GPS information for the UEs of various operators when selecting an A-GPS location method. In some cases, however, the SAS may not be equipped with a GPS receiver or the GPS receiver is faulty. In these cases, if the RNC is equipped with a GPS receiver and the GPS receiver works normally, the RNC should provide the GPS data management function and replace the SAS of each operator to provide the UEs with auxiliary GPS data.

Thus, different operators may use different SASs to implement the LCS according to their requirements for the location traffic, location precision, location method, and location information format.

As shown in the preceding method embodiment, different subsystems of a physical RNC are divided into different logical RNCs and each logical RNC is coupled to one service function entity that belongs to at least one operator; one logical RNC is coupled to at least one cell that belongs to at least one operator; and service function entities of different operators implement independent service functions through the coupled logical RNCs. In this way, different operators in the shared RAN may use different service function entities to meet their own service function requirements.

The following describes a system in an embodiment of the present invention. The system for implementing service functions in a shared RAN includes a physical RNC and at least one service function entity.

Different subsystems of the physical RNC are divided into different logical RNCs and each logical RNC is coupled to at least one service function entity.

The service function entity belongs to at least one operator and is used to implement an independent service function through the coupled logical RNC.

The following describes an RNC in an embodiment of the present invention. The RNC for implementing service functions in a shared RAN includes different logical RNCs configured by dividing different subsystems. Each logical RNC is coupled to at least one service function entity, and different operators implement independent service functions through the coupled service function entities and logical RNCs.

In the RNC, each logical RNC is independently coupled to one service function entity; or at least one logical RNC is independently coupled to one service function entity and at least two logical RNCs are coupled to another service function entity; or all the logical RNCs are coupled to the same service function entity.

The following describes a method for implementing service functions in a shared RAN in an embodiment of the present invention. The method includes: (1) coupling corresponding service function entities of different operators to different logical RNCs in a same physical RNC, where the logical RNCs are configured by dividing different subsystems of the physical RNC and each logical RNC is coupled to at least one service function entity; and (2) implementing, by service function entities, independent service functions through the coupled logical RNCs.

The dividing of different subsystems of the physical RNC into logical RNCs may be: one logical RNC is configured according to a subsystem including a CPU in the physical RNC.

The coupling relationship between each of the logical RNCs and one of the service function entities may be: (1) each of the logical RNCs is independently coupled to one of the service function entities, as shown in FIG. 5; or (2) at least one of the logical RNCs is independently coupled to one of the service function entities and at least two of the logical RNCs are coupled to the same service function entity, as shown in FIG. 6; or (3) all logical RNCs are independently coupled to the same service function entity, as shown in FIG. 7.

Multiple service function entities may be coupled to the same logical RNC to implement different service functions. As shown in FIG. 8, logical RNC 1 is coupled to service function entities 1 and 2. The two service function entities are used to implement different service functions. For example, service function entity 1 serves as a CBC and service function entity 2 serves as an SAS. Service function entities 1 and 2 coupled to logical RNC 1 may belong to the same operator.

As shown in the preceding embodiments, different subsystems of a physical RNC are divided into different logical RNCs and each logical RNC is coupled to one service function entity that belongs to at least one operator; one logical RNC is coupled to at least one cell that belongs to at least one operator; and service function entities of different operators implement independent service functions through the coupled logical RNCs. In this way, different operators in the shared RAN may use different service function entities to meet their own service function requirements.

Based on the descriptions of the preceding embodiments, those skilled in the art may understand that the present invention may be implemented by software and a necessary universal hardware platform. Based on such understandings, the technical solution of the invention or contributions to the conventional art may be embodied in a software product. The software product may be stored in a storage medium such as a read-only memory/random access memory (ROM/RAM), a magnetic disk or a compact disk, and incorporates several instructions to instruct a computer device such as a personal computer (PC), a server, or a network device, to execute the methods in all the embodiments of the present invention or in certain parts of the embodiments.

Although the exemplary embodiments of the present invention have been described through several embodiments, a myriad of changes, variations, alterations, transformations, and modifications may be suggested to those skilled in the art, and it is intended that the embodiments of present invention includes such changes, variations, alterations, transformations, and modifications as fall within the scope of the appended claims.

What is claimed is:

1. A method for implementing service functions in a shared Radio Access Network (RAN) comprising:
dividing subsystems of a physical Radio Network Controller (RNC) into at least two logical RNCs; and
coupling the at least two logical RNCs to at least two service function entities, wherein any one of the service function entities implements independent service functions through the corresponding logical RNC.

2. The method according to claim 1,
wherein each of the subsystem includes a Central Processing Unit (CPU) and is configured as one of the logical RNCs.

3. The method according to claim 1, wherein coupling the at least two logical RNCs to the at least two service function entities comprises:
independently coupling each of the logical RNCs to one of the service function entities.

4. The method according to claim 1, wherein coupling the at least two logical RNCs to the at least two service function entities comprises:
independently coupling at least one of the logical RNCs to one of the service function entities and coupling at least two of the logical RNCs to a same service function entity.

5. The method according to claim 1, wherein at least one of the service function entities comprises:
a Cell Broadcast Centre (CBC) configured to implement functions of a Cell Broadcast Service.

6. The method according to claim 1, wherein at least one of the service function entities comprises:
a Stand Alone Serving Mobile Location Centre (SAS) configured to implement functions of a location service.

7. The method according to claim 1, wherein the method further comprises: implementing different service functions by the at least two service function entities if the at least two service function entities are coupled to a same logical RNC.

8. The method according to claim 1, wherein the method further comprises:
implementing, by one service function entity of the at least two service function entities, independent service functions through one of the multiple logical RNCs if the multiple logical RNCs are coupled to a same function entity.

9. A Radio Network Controller (RNC) for implementing service functions in a shared Radio Access Network (RAN) comprising:
at least two logical RNCs divided according to subsystems of a physical RNC, wherein the at least two logical RNCs are coupled to at least two service function entities, and wherein any one of the service function entities implements independent service functions through the corresponding logical RNC.

10. The RNC of claim 9, wherein each of the logical RNCs is independently coupled to one of the service function entities.

11. The RNC of claim 9, wherein at least one of the logical RNCs is independently coupled to one of the service function entities and at least two of the logical RNCs are coupled to a same service function entity.

12. The RNC of claim 9, wherein one of the logical RNCs is corresponding to one of the subsystems of the physical RNC.

13. A system for implementing service functions in a shared Radio Access Network (RAN) comprising:
at least two logical RNCs divided according to subsystems of a physical RNC; and
at least two service function entities coupled to the at least two logical RNCs, wherein each of the service function entities belongs to at least one operator, and is configured to implement independent service functions through the corresponding logical RNC coupled to the service function entity.

14. The system of claim 13, wherein each of the logical RNCs is independently coupled to one of the service function entities.

15. The system of claim 13, wherein at least one of the logical RNCs is independently coupled to one of the service function entities and at least two of the logical RNCs are coupled to a same service function entity.

16. The system of claim 13, wherein one of the logical RNCs is corresponding to one of the subsystems of the physical RNC.

17. The system of claim 13, wherein at least one of the service function entities comprises:
a Cell Broadcast Centre (CBC) configured to implement functions of a Cell Broadcast Service.

18. The system of claim 13, wherein at least one of the service function entities comprises:
a Stand Alone Serving Mobile Location Centre (SAS) configured to implement functions of a location service.
